(19) United States
(12) Patent Application Publication
(10) Pub. No.: US 2026/0369482 A1
(43) Pub. Date: Nov. 19, 2026

(54) Electric Contact with Non-Conducting Recess and Conductive Portion

(71) Applicant: TE Connectivity Solutions GmbH, Schaffhausen (CH)

(72) Inventor: Sergey PEREKOPSKIY, Schaffhausen (CH)

(73) Assignee: TE Connectivity Solutions GmbH, Schaffhausen (CH)

(21) Appl. No.: 19/672,816

(22) Filed: May 11, 2026

(30) Foreign Application Priority Data
May 14, 2025 (EP) 25176430.4

(51) Int. Cl. H01H 1/06; H01H 1/20; H01H 33/16

(52) U.S. Cl. CPC H01H 1/06; H01H 1/20; H01H 33/16

(57) ABSTRACT

An electric contact reduces or avoids Lorentz forces acting on an electric contact in the electric switch in a case of short circuit and may open the switch, the contact provides the following: a contact surface, wherein the contact surface is configured to be reversibly separated, along a separation axis passing through a center of the contact surface, from an opposing contact surface of an opposing second contact; a contact periphery that extends at least partially around the separation axis at a radial distance from the separation axis; at least one conductive portion, which connects the contact surface with the periphery and only partially extends around the separation axis in the azimuthal direction; at least one recess, which only partially extends around the separation axis in the azimuthal direction; wherein the at least one recess and the at least one conductive portion are adjacent one another in the azimuthal direction.

### CROSS-REFERENCE TO RELATED APPLICATION

This application claims the benefit of European Patent Application No. 25176430.4 filed on May 14, 2025, in the European Patent Office, the whole disclosure of which is incorporated herein by reference.

### FIELD OF THE INVENTION

The invention relates to an electric contact for an electric switch and to an electric switch comprising at least one such electric contact. More specifically, the invention relates to an electric contact and an electric switch for high-current applications. The invention also relates to a contact pair having at least one such electric contact and to an electric switch comprising such a contact pair.

### BACKGROUND OF THE INVENTION

If, in a high-current application, a circuit is shorted when the electric switch is closed, currents exceeding 12 kA may flow through the electric switch and its electric contacts. It is desired that the electric switch withstand these currents at least until a fuse blows. It is the object of the invention to provide such an electric switch.

### SUMMARY OF THE INVENTION

This object is met by an electric contact for an electric switch, comprising a contact surface, wherein the contact surface is configured to be reversibly separated, along a separation axis passing through a center of the contact surface, from an opposing contact surface of a second contact; a contact end periphery that extends at least partially around the separation axis at a radial distance from the separation axis; at least one conductive portion, which connects the contact surface with the periphery and only partially extends around the separation axis in the azimuthal direction; at least one recess, which only partially extends around the separation axis in the azimuthal direction, wherein the at least one recess and the at least one conductive portion are adjacent one other in the azimuthal direction .

The object is also met by a contact pair for an electric switch, the contact pair comprising: a first contact as above and the second contact; wherein the second contact comprises at least one conductive portion for conducting electric current; wherein in a direction along the separation axis, the at least one conductive portion of the second contact overlaps the at least one recess of the first contact.

Finally, the object is also met by an electric switch with such a contact pair.

The provision of at least one recess and at least one conductive portion allow reducing the repellant forces that act on the closed electric contacts in the case of very high currents by being able to reduce or even avoid an overlap between the two closed contacts in the direction of the separation axis. By reducing or avoiding the overlap, repelling Lorentz forces decrease significantly. This in turn allows the contacts to stay closed so that no electric arc is generated which render the switch unusable or even may cause it to explode.

Herein, the term “recess“ is used synonymously to and interchangeably with the terms “cavity”, “opening” and/or “gap”.

The above solution can be further improved by adding independently of one another one or more of the following features, each of which having its own advantageous technical effect.

The separation axis may correspond to or extend along a switching direction, i.e. a direction, in which the contact and the second contact move relative to one another when the electric switch is moved from closed position to an open position. In the open position of the electric switch, the contact and the second contact are separated, whereas, in the closed position, the contact and the second contact are contacting each other. Usually, an electric current flows through the contact and the second contact in the closed position to supply e.g. electric energy to circuitry that is connected with the switch.

The at least one conductive section may be planar. Two of its surfaces may extend perpendicular to the separation axis. Its material thickness as measured along the direction of the separation axis may be constant or increase towards the contact surface.

The periphery of the contact end may be curved, straight and/or may comprise corners and/or curves in a plane perpendicular to the separation axis. For example, the periphery may be elliptic, circular, polygonal contour in a plane perpendicular to the separation axis. In one embodiment, the current flows from the periphery to the contact surface or from the contact surface to the periphery in the closed position of the switch in operation.

In order to be able to transmit high currents with low resistance, the contact end in its entirety or at least one of the conductive portion or the contact end periphery may consist of or comprise an electrically conducting material such as copper or aluminum.

The recess may be an opening or a cutout in the contact end. It may be filled completely or at least partly with dielectric material such as air or a solid dielectric material. In another embodiment, the recess may be filled completely or at least partly with an electrically conductive material which is electrically insulated from each of the at least one conductive portion. In yet another embodiment, the recess may be filled completely or at least partly with a magnetic material, for example a magnetic conductive and/or a paramagnetic material. In another embodiment, the recess may comprise a combination of any of these variants.

In one embodiment, the border between any or each at least one recess and each at least one conductive portion adjacent thereto may comprise at least one curved and/or linear section. For example, the border may be straight or curved. In another example, the border may extend radially from the contact surface to the periphery.

The conductive portion may connect the contact surface to the periphery along the shortest distance, e.g. be located on a straight line between the contact surface and the periphery. This leads to a short current path and helps to keep losses low.

The periphery may be closed in the azimuthal direction, e.g. provide a conductive ring around the contact surface.

The recess may be surrounded completely by electrically conductive elements of the contact end, the conductive elements comprising the at least one conductive portion, the periphery and/or the contact surface. In one example, the recess may be surrounded completely by at least one conductive portion and the periphery. In another example, the recess may be surrounded completely by the conductive portion, the periphery and the contact surface. Alternatively, the recess may be surrounded only partly by these conductive elements.

In one embodiment, the recess may have a sector cross-sectional shape in a plane perpendicular to the separation axis. In other embodiments, this cross-sectional shape may be polygonal or rounded, e.g. kidney-shaped.

The at least one conductive portion and the at least one recess may be located in a common plane that extends perpendicular to the separation axis.

The recess may extend from the contact surface to the periphery. In another embodiment, the recess may be open or unbounded in the radial direction, e.g. have no end in the radial direction pointing away from the separation axis.

In one embodiment, the at least one recess and the at least one conductive portion may be arranged to have radial symmetry with respect to separation axis.

All recesses may or may not have the same geometry and/or dimensions. All conductive portions may or may not have the same geometry and/or dimension. Each at least one recess may have the same geometry and/or dimensions as each at least one conductive portion.

The contact end may comprise any number of conductive portions and any number of recesses. The conductive portions and the recesses may be arranged alternatingly along the azimuthal direction. There may be two, three or four recesses and/or conductive portions.

The radius of the contact end, in particular the periphery, in a direction perpendicular to the separation axis may be larger than the radius of the contact surface in a direction perpendicular to the separation axis. For example, the diameter of the contact end, in particular, the radius of the periphery may be between three times and seven times the diameter of the contact surface. In another example, the cross-sectional area of the contact end may be between nine and fifty times the cross-sectional area of the contact surface. The contact surface therefore constitutes a restriction for the current flow. The current is guided radially towards or from the contact surface from or to the periphery along the at least one conductive portion.

In one embodiment, the contact surface may project along the separation axis from the contact end.

The contact surface may be planar and extend perpendicular to the separation axis.

The contact may include a contact pad that is attached, e.g. welded and/or riveted, to the contact end and the contact pad may include the contact surface. Alternatively, the contact surface may be integral or, synonymously, monolithic with the conductive portion, i.e. formed by the same block of material. The contact surface may simply be a portion of the conductive portion.

In one embodiment, the contact surface may consist of or comprise a different material than the conductive portion and/or contact end. For example, the contact surface may consist of or comprise a material that is configured to withstand an electric arc. In one example, the material may be a metal oxide, such as a silver tin oxide or a silver zinc oxide.

The contact surface may be located at a center of the contact end.

The contact may be a flat planar body, of which the height in the direction of the separation axis does not exceed the material thickness of the periphery and/or the conductive portion.

In another embodiment, however, the contact may be a contact stud. For example, the electric contact may comprise a stud body that terminates at the contact end and comprises an outer surface that joins the contact end periphery. The contact end may constitute an end of the stud body in a direction of the separation axis.

The stud body may extend along the separation axis, in particular it may be elongated in a direction along the separation axis.

In another embodiment, the stud body may extend at least partly around the separation axis. In yet another embodiment, the stud body may be a generalized cylinder. The cylinder axis may be parallel or coaxial to the separation axis. Specifically, the cross-section of the generalized cylinder in a plane perpendicular to separation axis may be circular, elliptic or polygonal, or any other geometrically suitable shape.

According to one embodiment, the stud body may be at least partly hollow, for example by enclosing an interior volume. A hollow stud body may constitute an invention that is independent of the structure of the contact end, e.g. of the provision of the at least one conductive portion and/or the at least one recess. Although the hollow stud body and the contact end with a conductive portion and/or a recess interact synergistically to avoid lift-off of the contact from the second contact in a closed switch, the hollow structure in itself already contributes to lowering the repelling forces in case of a short circuit, even if, instead of comprising at least one conductive portion and at least one recess, the contact end is a continuous plate-like conductive portion which extends across the entire base area of the generalized cylinder or has only very small openings or recesses. In such a configuration, the hollow stud body may be completely closed at the contact end by a single conductive portion, which covers the entire base.

The interior volume may be filled with a dielectric material, such as air, another gaseous substance or electrically insulating material. The interior volume may be closed, in particular sealed and/or hermetically closed.

In another embodiment, the interior volume may be enclosed by a shell surface of the stud body at least in the radial direction from the separation axis. The shell surface may extend around the separation axis in the azimuthal direction.

The interior volume may adjoin the at least one recess in a direction along the separation axis. In another embodiment, the material in the interior volume may continue in the material of the at least one recess, e.g. by both being air-filled or filled with a dielectric material.

The interior volume may adjoin the at least one conductive portion in a direction along the separation axis. For example, the at least one conductive portion may form a partial cover of the interior volume at the contact end.

Herein, the at least one recess or, synonymously, gap, opening or cavity, can be bounded by respective walls at the boundary of the recess and the conductive portion, i.e. in the azimuthal direction. Each of the walls can, but need not, surround a respective recess. The walls can extend parallel to the separation axis, e.g. entirely parallel thereto. The walls can extend continuously to the interior volume of the stud body, e.g. connecting the interior volume of the stud to the region outside of the electrical contact.

The contact in any of the embodiments described above may be a first contact of a contact pair for an electric switch, the contact pair further comprising the second contact.

In order to more efficiently reduce the repelling force acting on the first and second contact in case of a short circuit, the second contact may comprise at least one conductive portion for conducting electric current and the at least one conductive portion of the second contact may overlap the at least one recess of the first contact in a direction along the separation axis.

In one embodiment, the second contact may be configured as described above for the first contact. In another embodiment, the second contact may be a contact bridge.

### BRIEF DESCRIPTION OF THE DRAWINGS

In the following, various embodiments are described with reference to the drawings. According to the preceding description, any feature of an embodiment described below can be omitted if the technical effect of this feature is not needed for a particular application. Vice versa, any feature described above can be added to an embodiment described below if the technical effect associated with this feature is helpful for a particular embodiment.

In the drawings, the same reference numeral is used to designate elements that correspond to each other structurally and/or functionally. In the figures:

FIG. 1 shows a schematic perspective view of a contact;

FIG. 2 shows a schematic perspective view of a variant of the contact of FIG. 1;

FIG. 3 shows a schematic perspective view of a variant of the contact of FIG. 1;

FIG. 4 shows a schematic perspective view of a variant of the contact of FIG. 1;

FIG. 5 shows a schematic perspective view of a variant of the contact of FIG. 1;

FIG. 6 shows a schematic perspective view of a variant of the contact of FIG. 1;

FIG. 7 shows a schematic cut view of a contact pair in the closed state;

FIG. 8 shows a schematic cut view of a variant of a contact pair;

FIG. 9 shows a schematic perspective view of a variant of the contact of FIG. 1;

FIG. 10 shows a schematic cut view of the contact of FIG. 9;

FIG. 11 shows a schematic cut view of a variant of the contact of FIG. 9;

FIG. 12 shows a schematic perspective view of a contact pair;

FIG. 13 shows a schematic view of a contact bridge and contacts:

FIG. 14 shows a schematic view of a variant of a contact bridge;

FIG. 15 shows a schematic perspective view of an electric switch;

FIG. 16 shows a schematic perspective view of a variant of an electric switch.

### DETAILED DESCRIPTION OF EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as "lower," "upper," "horizontal," "vertical," "above," "below," "up," "down," "top" and "bottom" as well as derivative thereof (e.g., "horizontally," "downwardly," "upwardly," etc.) should be construed to refer to the orientation as then described or as shown in the drawing under discussion. These relative terms are for convenience of description only and do not require that the apparatus be constructed or operated in a particular orientation unless explicitly indicated as such. Terms such as "attached," "affixed," "connected," "coupled," "interconnected," and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

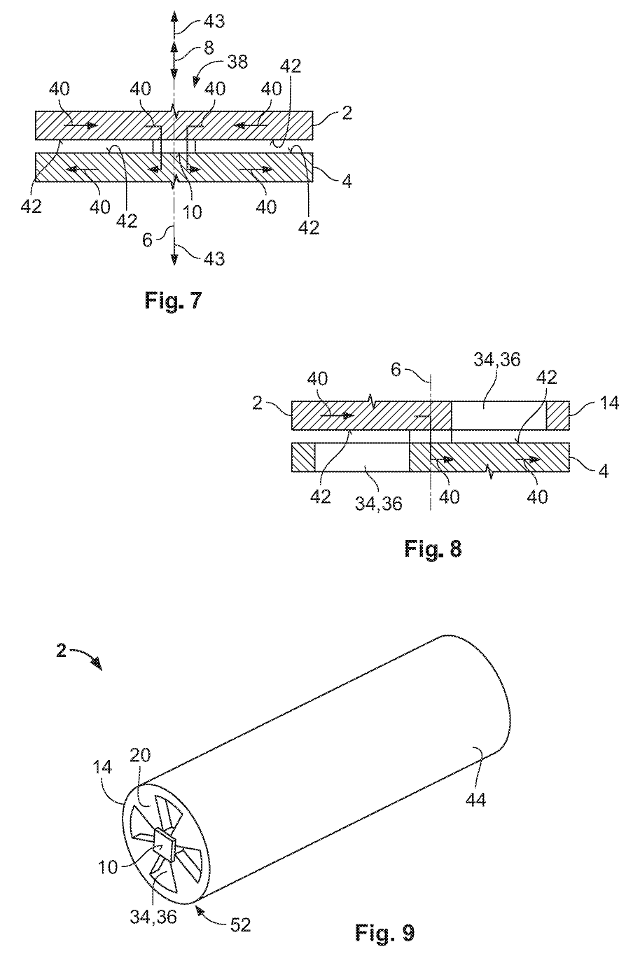

First, an electric contact 2 is described with reference to FIG. 1. The contact 2 is configured to be moved against and separated from a mating contact 4 (shown e.g. in FIG. 7) along a separation axis 6, which defines a switching direction 8.

If the contact 2 is in contact with the mating contact 4, an electric current may flow between the contacts 2, 4, e.g. for conducting electric energy from an energy source to circuitry (not shown) which is connected to one of the contacts 2, 4. If the contacts 2, 4 are separated, the circuitry is separated from the energy source.

For actually contacting the mating contact 4, the contact 1 comprises a contact surface 10. The contact surface 10 may be planar and extend in a plane 12 that is perpendicular to the separation axis 6. The separation axis 6 intersects the contact surface 10.

The contact 2 comprises a periphery 14 that extends at least partly around the separation axis 6. The separation axis 6 may intersect a center 16 of the contact 2, which may be a center defined by the periphery 14. If, for example, the periphery 14 is at least partly polygonal, circular or elliptic, the center 16 may be the center of the respective polygon, circle or ellipsis. As shown in FIG. 1, the periphery 14 may form a ring around the separation axis 6.

The periphery 14 is electrically conductive. In operation, current flows between the periphery 14 and the contact surface 10. The periphery 14 is spaced apart in a radial direction 18 from the separation axis 6.

At least one conductive portion 20 connects the contact surface 10 electrically to the periphery 14. In FIG. 1, four conductive portions are only shown by way of example.

Each at least one conductive portion 20 may connect the contact surface 10 to the periphery 14 in a straight line 22. The at least one conductive portion 20 extends at least partly around the separation axis 6 and/or the center 16, respectively, in an azimuthal direction 24. The azimuthal direction 24 substantially corresponds to a peripheral direction around the separation axis 6 and the switching direction 8. The number of conductive portions 20 may be chosen according the specific application. Any number of conductive portions 20 may be adequate. According to one example, the number may be between one and ten.

As shown, the at least one conductive portion 20 may have the shape or footprint of a circle segment in a plane perpendicular to the separation axis 6, in particular in plane 12. Other shapes, such as at least partly polygonal, at least partly circular and/or kidney-shaped, are also possible. Ultimately, the shape of the at least one conductive portion 20 may be determined by the shape of the mating contact 4 as will be explained further below.

A material thickness 26 of the at least one conductive portion 20 in a direction along the separation axis 6 may be constant, or increase or decrease in the radial direction 18. In one embodiment, the area of a conductive cross-section 28 of the at least one conductive portion 20 in a plane perpendicular to the radial direction 18 may be constant, or may vary in the radial direction. According to one embodiment, the area of the conductive cross-section 28 may not vary more than ±20 percent in the radial direction 18.

The contact surface 10 may be integral or, synonymously, monolithic with the conductive portion 20, e.g. formed from the same block of material as the conductive portion 20, in one embodiment.

In any case, the contact surface 10 may protrude from the conductive portion 20 in a direction along the separation axis 6, in particular towards the mating contact 4. In this configuration, the contact surface 10 represents a constriction to the current flow through the contact 2. Using such a constriction may ensure a higher contact pressure and a geometrical setting that is easier to control using available manufacturing tolerances.

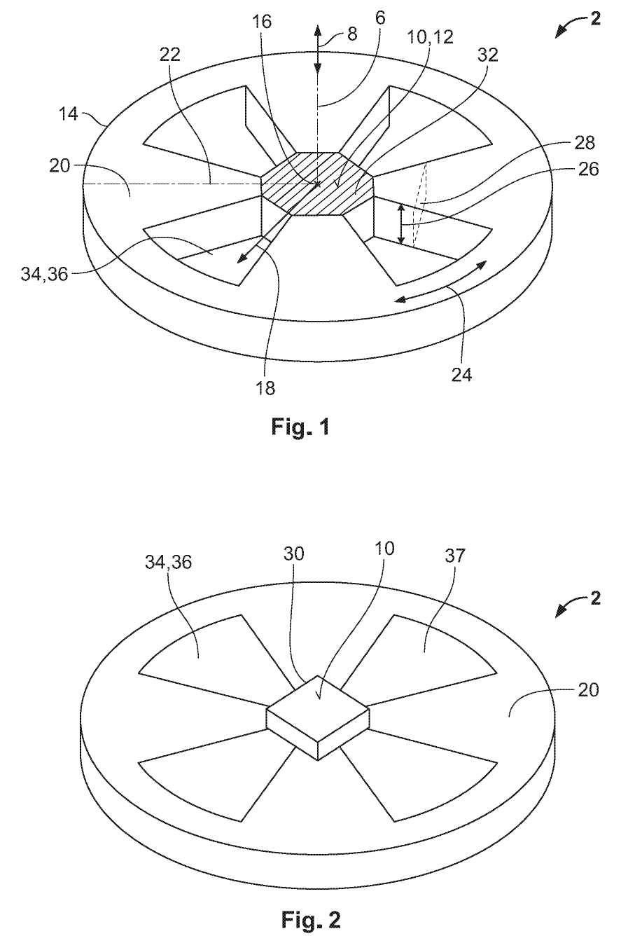

In the embodiment of FIG. 2, the contact surface 10 is shown to be formed by a contact pad 30 that is attached to the at least one conductive portion 20.

The smallest cross-sectional area 32 (hatched in FIG. 1) of the contact surface 10 in a plane perpendicular to the separation axis 6 may be larger than the smallest cross-section 28. In one embodiment, the cross-sectional area 32 of the contact surface 10 may be at least as large as the sum of the smallest cross-sectional areas 28 of all conductive portions 20.

The contact surface 10 may consist of or comprise a material that is different from the material of the conductive portion 20. In particular, the material of the contact surface 20 may have a higher wear resistance against electric arc, e.g. by consisting of or containing a metal oxide, such as a zinc oxide and/or a tin oxide. The entire contact pad 30, if one is present, may be formed from such a material.

In the azimuthal direction 24, the at least one conductive portion 20 and at least one non-conducting portion 34 are arranged alternatingly. The non-conducting portion 20 is configured to not conduct a current from the periphery 14 to the contact surface 10 in operation. The at least one non-conducting portion 34 may be formed from a dielectric material, which may be solid or gaseous. In its simplest form, shown in FIG. 1, each or any at least one non-conducting portion 34 may be a recess (or, here synonymous, gap, opening or cavity) 36 of the contact 2, which is filled with material. Parts or all of the at least one recess 36 may be filled with a non-conducting material, e.g. of a dielectric ceramic instead of air in an alternative embodiment. Again alternatively, the at least one non-conducting portion may consist of or comprise a magnetic, e.g. paramagnetic, material, a conductive material and/or a magnetic conductive material. Any conductive material should be electrically insulated from the conductive portion. In FIG. 1, the recess 36 is filled with (ambient) air, in FIG. 2 it is filled with a solid dielectric material 37. The use of a solid dielectric material 37 is independent of the use of a contact pad 30, although both are shown in a single figure.

As shown, the at least one non-conducting portion 34 may have the shape or footprint of a circle segment in a plane perpendicular to the separation axis 6. Other shapes, such as at least partly polygonal, at least partly circular and/or kidney-shaped, are also possible. Ultimately, the shape of the at least one conductive portion 34 may be determined by the shape of the mating contact 4 as will be explained further below.

Each or any at least one conductive portion 20 and/or each or any at least one recess may have symmetry in an axial plane, i.e. a place in which the separation axis 6 is contained. Alternatively or cumulatively, the arrangement comprising each at least one recess 36 and each at least one conductive portion 20 may have radial symmetry about the separation axis 6.

Each at least one conductive portion 20 may have the same geometry and/or dimensions. Each at least one recess 36 may have the same geometry and/or dimension. Each at least one conductive portion 20 may have the same geometry and/or dimension as each at least one recess 36.

In the embodiment of FIG. 1, the recess 36 (the non-conducting portion 34) is surrounded by the periphery 14 and at least one conductive portion 20. More specifically, the recess 36 extends in the radial direction 18 up to the periphery 14 and in the azimuthal direction 24 to a conductive portion 20.

The conductive portion 20 may extend from the center 16 to the periphery. If the contact comprises more than one conductive portion 20, all conductive portions may join at the center 16.

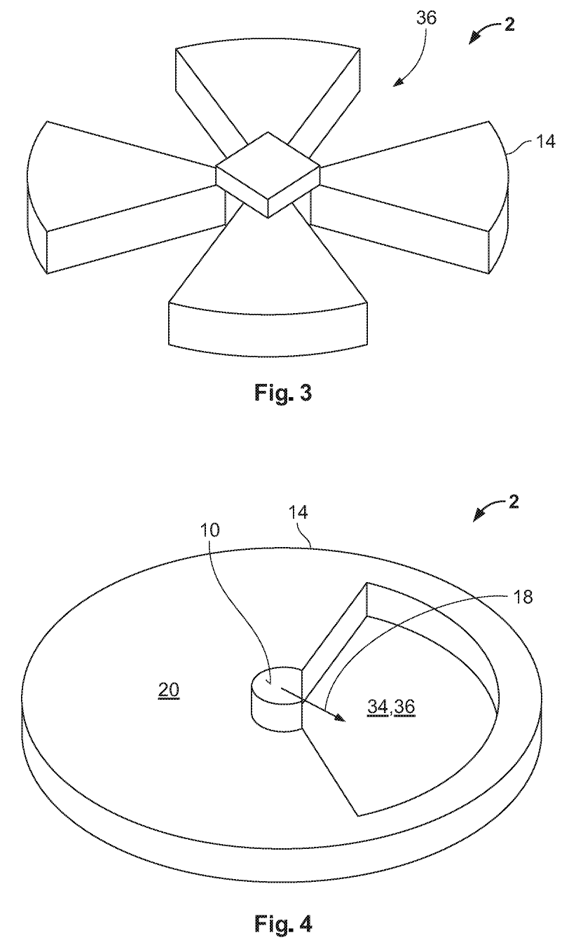

In FIG. 3, a variant of the contact 2 is shown, where the at least one recess 36 is open in the radial direction 18. The periphery 18 does not enclose the non-conducting portion 34. Otherwise, the embodiment of FIG. 3 corresponds to the embodiment of FIG. 1 or 2.

In FIG. 4, the contact 2 comprises a single recess 36 and a single conductive portion 20. The recess is limited in the radial direction 18 by the periphery 14.

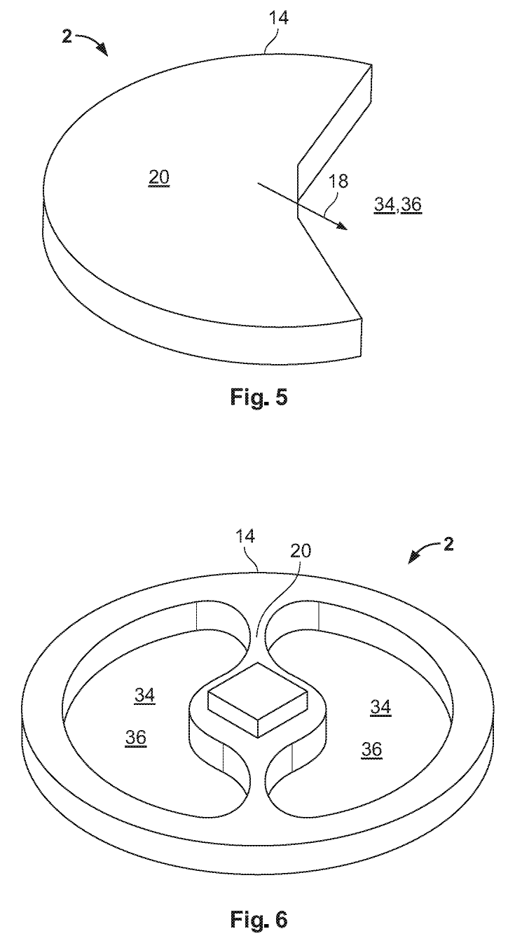

FIG. 5 shows the variant of FIG. 3 with a recess 36 that is open in the radial direction 18.

FIG. 6 shows a variant with a recess 36 that is not shaped like a circle segment as in the previous variants.

The effect of the contact 2 comprising the at least one conductive portion 20 and the at least one (non-conducting) recess 36 is explained with reference to FIGS. 7 and 8. Both figures show a contact pair 38 comprising a contact 2 and a mating contact 4. Both contacts 2, 4 contact each other via at least one elevated or protruding contact surface 10. The direction of the flow of an electric current through the closed contacts 2, 4 is indicated with the arrows 40. In case of e.g. a short circuit, this current 40 becomes particularly large.

In FIG. 7, neither the contact 2, nor the mating contact 4 have a recess 36. Thus, the current 40 has opposite flow direction in the sections 42 of the contacts 2, 4 that overlap in the switching direction. The opposite directions in opposed sections 42 generate a Lorentz force 43 according to Ampere’s force law that tries to move the two contacts 2, 4 away from one another.

If, however, the recess 36 or non-conducting portion 34 of the contact 2, 4 overlaps the conducting section 42 of the respective opposite, mating, contact 4, 2, as shown in FIG. 8, there is no opposing current flow as there are (hardly) opposing sections 42. Consequently, the Lorentz force that in FIG. 6 tries to move the contacts 2, 4 apart is at least greatly reduced, if not completely abolished. This works for any contact 2, 4 with a non-conducting section 34 as described above.

The contact 2 may be flat, e.g. a plate or a disk. As an alternative to such an embodiment, FIG. 9 shows a contact 2, which comprises a stud body 44.

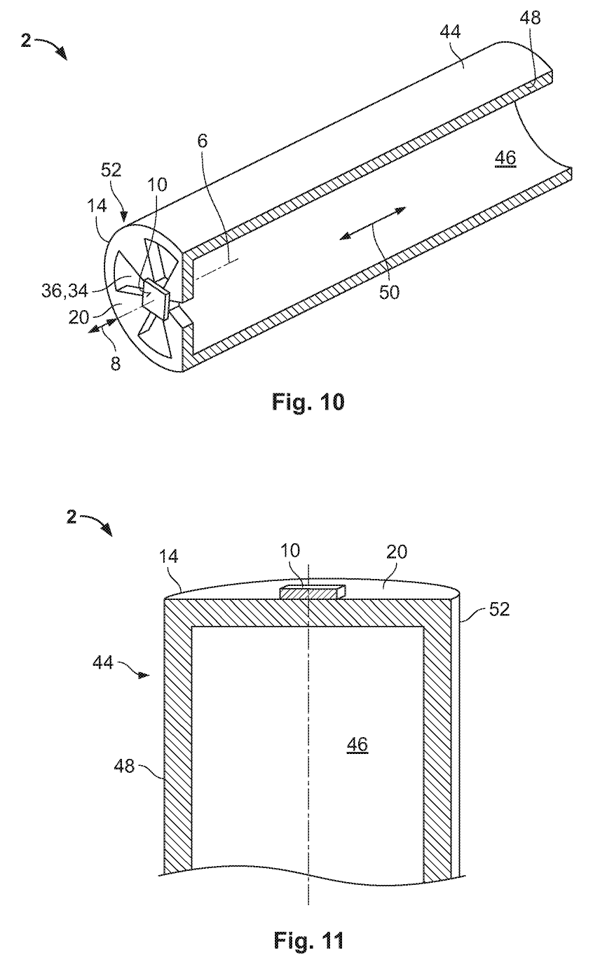

The stud body may be at least partly hollow, as shown in FIG. 10. The at least partly hollow stud body 44 may have an interior volume 46 that is at least partly enclosed by a shell 48 of the stud body 44. The stud body 44 may be a generalized cylinder, which may be elongated. The height direction 50 of the cylinder may be parallel to the separation axis 6. The separation axis 6 may be coaxial to a center axis of the generalized cylinder. The generalized cylinder may have a circular, elliptic, oval or polygonal cross-section, or any other suitable cross-section.

At a contact end 52 of the stud body 44 of FIGS. 9 or 10, the at least one conductive portion 20, the at least one recess 36 and the contact surface 10 are located. The contact end 52 is located at one of the ends of the stud body that are pointing along the switching direction 8.

The interior volume 46 may adjoin the at least one recess 36 or non-conducting portion 34. If, for example, the recess 38 is air-filled, the interior volume 46 may be connected to the outside of the stud body 44 through the recess 38.

The interior volume 46 may adjoin the at least one conductive portion 20. The at least one conductive portion 20 may form a cover of the interior volume 46 that at least partly covers the interior volume in a direction along the separation axis 6.

Instead of being at least partly hollow, the stud body 44 may be massive. Moreover, an at least partly hollow stud body 44 may comprise a contact end 52, which is completely covered by an azimuthally continuous conductive portion 20, i.e. does not have a recess 36 or non-conducting portion 34 as the provision of the interior volume 46 already reduces repelling forces at the contacts 2, 4 in a short-circuit situation. Such an embodiment is shown in FIG. 11.

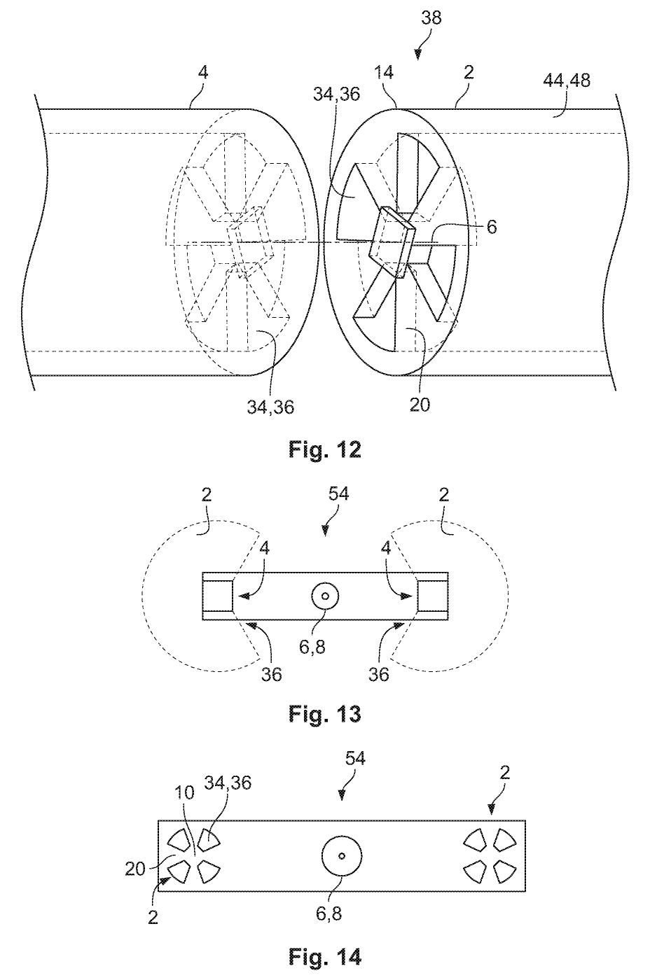

According to FIG. 12, the contact pair 38 may comprise two contacts 2, 4, each with a stud body 44. In order to reduce repelling Lorentz forces, at least one conductive portion 20 of the contact 2 overlaps the non-conducting portion 34 along the separation axis when the contacts 2, 4 contact each other. In FIG. 2, non-visible lines are dashed.

At the contact end 52, the shell 48, in particular its outer surface, may continue as the periphery 14. Specifically, the shell 48 may transition seamlessly into the periphery 14 at the contact end 52. Alternatively or cumulatively, the inner surface of the shell 48 may transition seamlessly into a wall that limits the at least one recess in the radial direction 48. Avoiding any sharp corners or steps helps to suppress arcs in a short-circuit situation.

The contacts 2, 4 may be identical and rotated relative to one another about the separation axis 6 so that a conductive portion 20 of the contact 2 faces a recess 36 of the contact 4 as is also shown in FIG. 8.

As shown in FIG. 13, a contact 4 may be part of a contact bridge 54. The at least one non-conducting portion 34 of an opposite contact 2 is arranged opposite the contact bridge 54 in the switching direction 8. It is to be noted that a contact 2 as e.g. shown in FIG. 2 may be integrated in the contact bridge 54, e.g. by in that at least one recess 36 is stamped into the contact bridge 4. FIG. 14 shows such a contact bridge 54.

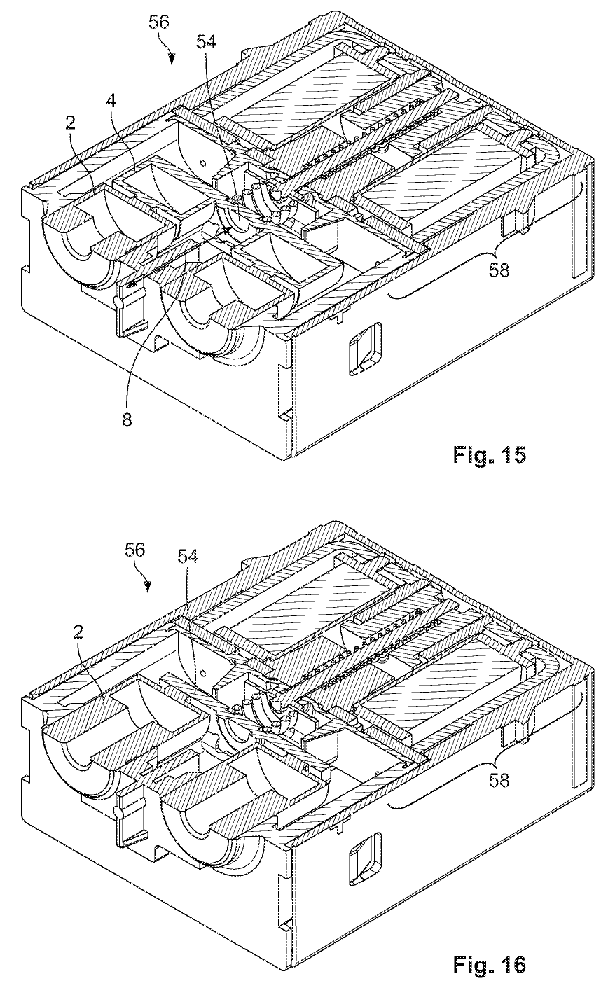

FIG. 15 shows an electric switch 56 that comprises at least one stationary contact 2 and at least one fixed contact 4, which both may configured as described above. The contacts 2, 4 may be provided pairwise and e.g. be part of a contact bridge 54. The electric switch 56 further comprises a drive section 58 that acts on at least one of the contacts 2, 4 to close and separate them in the switching direction 8.

In the variant of FIG. 16, only the stationary contacts 2 of the switch 56 are configured as described above. Of course, it is also possible to design only the fixed contacts 4 as described above.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. An electric contact for an electric switch, comprising:
a contact surface, wherein the contact surface is configured to be reversibly separated, along a separation axis passing through a center of the contact surface, from an opposing contact surface of an opposing second contact;
a contact periphery that extends at least partially around the separation axis at a radial distance from the separation axis;
at least one conductive portion, which connects the contact surface with the periphery and only partially extends around the separation axis in the azimuthal direction;
at least one recess, which only partially extends around the separation axis in the azimuthal direction,
wherein the at least one recess and the at least one conductive portion are adjacent one another in the azimuthal direction.

2. The electric contact according to claim 1, wherein
the at least one recess is at least one of:
at least partly filled with a non-conductive material,
conductively insulated from each of the at least one conductive portion or
comprising a magnetic and/or a magnetic conductive material.

3. The electric contact according to claim 1, wherein
the recess has a shape of a circle segment.

4. The electric contact according to claim 1, wherein

5. The electric contact according to claim 1, wherein
the at least one conductive portion and the at least one recess are located in a plane that extends perpendicular to the separation axis.

6. The electric contact according to claim 1, wherein
the contact comprises a plurality of conductive portions and a plurality of recesses which are arranged alternatingly along the azimuthal direction.

7. The electric contact according to claim 1, wherein
the electric contact comprises a stud body, the stud body
terminating at the contact end and
comprising an outer surface that joins the contact end periphery.

8. The electric contact according to claim 7, wherein
the stud body is at least partly hollow.

9. The electric contact according to claim 7, wherein
the stud body encloses at least partly an interior volume.

10. The electric contact according to claim 9, wherein
wherein the interior volume adjoins the at least one recess in a direction along the separation axis.

11. The electric contact according to claim 9, wherein
wherein the interior volume adjoins the at least one conductive portion in a direction along the separation axis.

12. A contact pair for an electric switch, the contact pair comprising:
a first contact according to the electric contact of claim 1 and
a second contact;
wherein the second contact comprises at least one conductive portion for conducting electric current;
wherein in a direction along the separation axis, the at least one conductive portion of the second contact overlaps the at least one recess of the first contact.

13. The contact pair according to claim 12, wherein
the second contact comprising:
a second contact surface, wherein the second contact surface is configured to be reversibly separated, along a separation axis passing through a center of the second contact surface, from an opposing contact surface of an opposing first contact;
a second contact periphery that extends at least partially around the separation axis at a radial distance from the separation axis;
at least one second conductive portion, which connects the second contact surface with the second periphery and only partially extends around the separation axis in the azimuthal direction;
at least one second recess, which only partially extends around the separation axis in the azimuthal direction,
wherein the at least second one recess and the at least one second conductive portion are adjacent one another in the azimuthal direction.

14. The contact pair according to claim 12, wherein
the second contact is a contact bridge.

15. An electric switch, comprising at least one contact pair according to claim 12.
